(19) United States
(12) Patent Application Publication
(10) Pub. No.: US 2002/0035629 A1
(43) Pub. Date: Mar. 21, 2002

(54) Methods and apparatus for correlating identifiers with electronic information

(76) Inventors: Andrew Sullo, Houston, TX (US); Gregory Sullo, Pearland, TX (US)

Correspondence Address: FULBRIGHT & JAWORSKI L.L.P., A REGISTERED LIMITED LIABILITY PARTNERSHIP, 600 CONGRESS AVENUE, SUITE 2400, AUSTIN, TX, 78701, US

(21) Appl. No.: 09/899,809

(22) Filed: Jul. 5, 2001

Related U.S. Application Data
(60) Provisional application No. 60/215,955, filed on Jul. 5, 2000.

(51) Int. Cl. G09G 5/00; G06F 15/16; G06F 15/173; G06F 17/60

(52) U.S. Cl. 709/225; 709/219; 345/733; 705/26

(57) ABSTRACT

Systems, methods, and computer media for associating information from print media with online information via telephone number identifiers. A telephone number identifier is associated with a network address. An online query field is provided and configured to receive the telephone number identifier from a remote user. The address is displayed to the remote user in response to the query, and a link to the address is provided to the remote user.

This application claims priority to provisional patent application Ser. No. 60/215,955 filed Jul. 5, 2000, entitled, “METHODS AND APPARATUS FOR CORRELATING IDENTIFIERS WITH ELECTRONIC INFORMATION” by Andrew Sullo and Gregory Sullo. The entire text of the above-referenced disclosure is specifically incorporated by reference herein without disclaimer.

### BACKGROUND OF THE INVENTION

1. Field of the Invention

The present invention relates generally to the fields of computerized information. More particularly, it concerns methods and apparatus for correlating unique identifiers with information in electronic format. Even more particularly, it concerns associating identifiers such as telephone numbers with Internet addresses and/or databases. These identifiers may be placed in print media to direct readers to easily retrieve electronic information related to the print media from, for instance, the Internet or another computer network (or database).

2. Description of Related Art

The advent of the World-Wide Web (the web, or generally, the Internet) has provided a unique opportunity for consumers to search through vast amounts of information remotely. The web is a global collection of inter-connected web pages that allows users to navigate information and sites on the Internet intuitively, without technical knowledge of the underlying data network. Web pages are maintained or hosted by servers. The software necessary to run these servers is relatively straightforward and is available on a wide range of computer platforms including personal computers. Equally available is a form of client software, known as a Web browser, which is typically a graphical interface used to display web pages on a client system.

Generally, a server is one or more nodes on a network that is operable to provide certain services to other nodes on the network. The specific services that may be provided by a server are determined by the server's software and configuration. For example, a typical web server is a system running software and configured such that it may distribute information to other network nodes that request information. The node making such a request (known as the client) is typically a personal computer connected to the network.

Because of its unique ability to disseminate a wide range of information, the Web has become a haven for online classified ads, news stories, magazines, commercial sites, etc. Although vast amounts of information are currently available on the web, it is often a daunting to task to locate the information one is seeking. A typical way for a user to locate a web page or web site is to use a search engine, and then to review the web page and use links in the web page to find other web pages of interest. Search engines usually take a user query as input and attempt to find web pages related to that query. Queries are usually in the form of one or several words which describe the subject matter of interest to the user. Most search engines operate by comparing the query to an index of a document collection in order to determine if the content of one or more of those documents matches the query. Since most casual users of search engines do not want to type in long, specific queries and tend to search on popular topics, there may be thousands of documents that are at least tangentially related to the query.

However, given the millions of web pages on the Internet (only a fraction of which have been indexed by search engines), finding a desired web page or desired information, such as information relating to a particular item sought to be purchased or a particular news story desired to be read is often difficult, or even impossible. When a user accesses one of the leading search engines, the search can produce hundreds, even thousands, of hits (i.e., records). This deluge of information is often too overwhelming to review, cull, and select. This problem is exacerbated by the failure of most search engines to group the hits in the search result list in any meaningful way.

The marriage of certain print media with online information has alleviated some of the problems mentioned above. Specifically, certain major advertisers sometimes list their specific web address (or URL) so that readers may later log onto the Internet and visit the company's web page. Knowing the URL of the company, one may correspondingly avoid using one or more search engines to find information relating to that company. In the context of classified ads, it is becoming more common for ads to include specific addresses linking to one or more web pages where the reader can visit to learn more about the item being sold. For instance, one may include a web address pointing to a personal web page that displays pictures of a bicycle being offered for sale in a local newspaper classified section. By having the specific web address, the reader of the local classified section may go directly to the page of interest (the page showing pictures of the bicycle) by typing in the referenced address without having to type in a query such as, “used bicycles for sale in houston texas” into a search engine. Such a query results in, at the time this application is being written, in over 500 hits. Again, such a deluge of information, much of which is not even relevant, is not useful.

Although such classified ads offer the consumer more information and ease the need for constant use of search engines, problems remain. Specifically, current systems do not connect print media to the Internet. For example, an Internet ad placed in the newspaper by a web site such as YAHOO may have to include an ad number as well as the actual phone number associated with that ad. This is a needless redundancy, but is currently necessary to find the appropriate classified ad on YAHOO's site. The following Internet sites do provide classified ads, but do not utilize the advantageous technology described herein: yahoo.com, houstonfsbo.com, houston-classifieds.com, forsalebyowner.com, and classifieds.com.

Further, a problem arises with current systems because the nature of Internet addresses is that most addresses are hard to remember and quite long. For instance, it would not be uncommon for a classified ad to include a web address that appeared as follows: http://www.myhomepage/˜david/classified/mybicycle.html. Although one could type in such an address to view, for instance, the picture of a bicycle being offered for sale, the address is very hard to remember and, further, its long length translates into a more expensive print media classified ad (such ads often charge on a per-word or per-line basis).

In view of at least the above, it would be highly desirable to develop techniques that would allow for simple correlation between print media and computerized information, such as information on the web. Specifically it would be advantageous to offer users the ability to enter a easy-to-remember identifier into a text entry field that would then direct the user to one or more web pages that have been associated with that number. More specifically, it would be advantageous if telephone numbers or the like could be automatically correlated to associated web addresses so that a user, upon entering a telephone number, could be directed to one or more web pages containing information that has been associated to that telephone number. It would be advantageous if the identifier (such as a telephone number, letters, or alphanumeric sequence) could be associated not only to classified ads but also to any other type of information such as news stories, commercial sites, or any other sites on global computer networks or databases.

Problems enumerated above are not intended to be exhaustive, but rather are among many that tend to impair the effectiveness of previously known techniques concerning information retrieval. Other noteworthy problems may also exist; however, those presented above should be sufficient to demonstrate that methodology appearing in the art have not been altogether satisfactory. In particular, existing techniques do not adequately allow users to enter a simple identifier in order to retrieve information associated with the identifier.

### SUMMARY OF THE INVENTION

In one respect, the invention is a system for correlating an identifier in print media to information in electronic format. The system includes a graphical user interface and a server. The graphical user interface is coupled to a network that includes the information, which is located at a network address. The user interface is configured to receive a request from a remote user, the request including the identifier from the print media. The server is coupled to the network. The server is configured to receive the request, correlate the identifier with the address, display the address corresponding to the identifier, and provide a link to the information using the address.

In other respects, the network may include the Internet. The network may include a local area network. The graphical user interface may include a web page. The identifier may include a telephone number. The telephone number may include an extension. The server may be further configured to display an advertisement corresponding to the telephone number.

In another respect, the invention is a method for correlating an identifier in print media to information in electronic format. An identifier is assigned to an electronic address of the information. A query including the identifier is received with a server over a network from a remote user. The address corresponding to the identifier is displayed, and a link to the information is provided using the address.

In another respect, the invention is a method for associating information from print media with online information via a telephone number identifier. The telephone number identifier is associated with a URL address. An online query field configured to receive the telephone number identifier from a remote user is provided. The URL address is displayed to the remote user in response to the query, and a link to the URL address is provided.

In other respects, the information from print media and the online information may include classified advertisement information. The information from print media and the online information may include news information. The information from print media and the online information may include commercial information. The telephone number identifier may include an extension. The online query field may be configured to receive the telephone number identifier with or without the extension. The method may also include displaying two or more URL addresses associated with two or more extensions in response to the receipt of the telephone number identifier without the extension. The method may also include displaying an advertisement corresponding to the telephone number.

In another respect, the invention is a computer readable media containing program instructions for associating information from print media with online information via a telephone number identifier. The media includes instructions for: associating the telephone number identifier with a URL address; providing an online query field configured to receive the telephone number identifier from a remote user; displaying the URL address to the remote user in response to the query; and providing a link to the URL address.

In other respects, the instructions may include HTML code. The information from print media and the online information may include classified advertisement information. The information from print media and the online information may include news information. The information from print media and the online information may include commercial information. The media may also include instructions for displaying an advertisement corresponding to the telephone number identifier.

These features and associated advantages will become apparent with reference to the following detailed description of specific embodiments in connection with the accompanying drawings, wherein like reference numerals have been applied to like elements.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 illustrates correlation according to a unique identifier in accordance with embodiments of the present disclosure;

FIG. 2 is a process flow for methodology in accordance with embodiments of the present disclosure.

### DESCRIPTION OF ILLUSTRATIVE EMBODIMENTS

The present disclosure describes apparatus and methods for correlating identifiers to information in electronic format. More particularly, the present disclosure allows for identifiers to be used to easily, and intuitively direct readers of print media to associated electronic information stored on the web (or a database). The techniques described herein advantageously allow for a simple, instinctive way to access information. In particular, if telephone numbers are used as the identifiers, one may access varied information in electronic format just by knowing an associated telephone number. For instance, by typing in a telephone number into a query field, one may be directed to items being sold by the person having that phone number, or one may be directed to the web page of the store having that phone number, or one may be directed to a news story that has been correlated with that phone number. The applications of such technology are indeed vast, and with the benefit of the present disclosure, those having skill in the art will comprehend that the techniques disclosed herein may be modified and applied to several different applications. The present disclosure and claims attached hereto cover all such modifications that fall within the scope and spirit of this disclosure.

Currently, many different classified ad sites exist on the Internet. Each of these sites catalogs its classified ads by some kind of random or sequential numbering system. To date, none of these sites have used telephone numbers as their numbering scheme for cataloging. More importantly, these classified ad sites have not tried to link web classified ads to the newsprint media classified ads. Since these online classified sites have been unconcerned with linking online classified ads with the newsprint classified ads, little attention has been paid to developing a numbering system that is compatible with both the Internet and the newsprint.

For simplicity of use and optimization of cost, it may be important for the numbering system, or identification system, to be as concise as possible because newsprint media typically charges people to place newsprint classified ads on a per line or per character basis. For this reason, using the telephone number as the unique identifier in an online classified ads database that connects online classified ads with newsprint classified ads is important because it eliminates the possibility of having to put both a telephone number and another online classified ad (which often amounts to a series of seemingly random numbers or characters) in the same newsprint classified ad.

Although examples below concern the use of telephone numbers as the identifier for classified ads, those having skill in the art will understand, with the benefit of the present disclosure, that other identifiers may be used to associate any different type of information.

The following examples are included to demonstrate specific embodiments of the invention. It should be appreciated by those of skill in the art that the techniques disclosed in the example which follow represent techniques discovered by the inventors to function well in the practice of the invention, and thus can be considered to constitute specific modes for its practice. However, those of skill in the art should, in light of the present disclosure, appreciate that many changes can be made in the specific embodiments which are disclosed and still obtain a like or similar result without departing from the spirit and scope of the invention.

### EXAMPLE 1

Attached hereto as Appendix 1 is a listing of source HTML code that may be used to implement one embodiment of the present disclosure. This code implements an embodiment in which telephone numbers may be associated with URLs. Features of this implementation are described below in Example 2.

### EXAMPLE 2

In one embodiment, an online web site named, for instance, EZcodes.com may be used as a site into which users may enter the identifier(s) associated with information in electronic form. In particular, the EZcodes.com web page may provide a text box into which users enter the identifier(s), and the EZcodes.com page subsequently returns to the user a selection of links to associated sites containing information. Alternatively, the page may be configured to display associated information directly.

On the EZcodes.com web site, visitors may be able to query the EZcodes.com database of classified ads by simply typing in the phone number of the ad they wish to view. The process may be summarized, according to one embodiment, as follows:

Person A visits the EZcodes.com web site

Person A creates an online classified ad

Person A's telephone number and letter extension (Ezcode number) is automatically assigned to the classified ad.

Person A places an ad in his local newspaper along with his telephone number and letter extension.

Person B reads ad and visits Ezcode or other web site that uses the EZcodes technology disclosed herein

Person B types in the telephone number and letter extension.

The ad is displayed

Such an embodiment is made possible through accessing/querying/creating unique identifier-telephone numbers. One method of implementing this is disclosed in Appendix 1.

In one embodiment, a person's telephone number may be associated with a particular URL or database query. Also, if a particular phone number should have multiple newsprint classified ads associated with it, one or more “letter extensions” may be placed on the end of the phone number. These letter extensions may direct viewers to a specific classified ad. Using this technology, newspapers or other print media may become a daily Internet guide that will help readers find more detailed information on the Internet about a specific classified ad or story.

The present disclosure allows someone to find more information about a specific newspaper classified ad by going to the ezcodes.com database (or web site using technology disclosed herein) and typing the telephone number or the telephone number and its corresponding letter extension in as the unique identifier to access more information about that particular newsprint classified ad.

Due to the limited character space in a typical newsprint classified ad section, it is advantageous that the domain name and extension have as few letter characters as possible. If the domain name and extension is not small, people placing classified ads may not have enough space in the newsprint classified ad to describe the item they are selling. For this reason, it may waste character space in the newspaper to have both a phone number and a different ad number.

For example, Ad #3, due to its shorter length may be advantageous to Ad #1 and Ad#2 (See below).

Ad#1—Without Ezcode technology disclosed herein

For Sale 1995 Red Honda

Accord LS A/C, Sunroof

713-555-9055

http://www.blahoo.com/classifiedads/index/cars/smith.html

Ad#2—Without Ezcode technology disclosed herein

For Sale 1995 Red Honda

Accord LS A/C, Sunroof

713-555-9055

http://www.classifiedadsRus.com

Listing # 13934823bc

Ad#3—With Ezcode technology disclosed herein

For Sale 1995 Red Honda

Accord LS A/C, Sunroof

713-839-9055a

www.ezcodes.com

As may be seen with reference to the above example, the methodology subject of one embodiment of the present disclosure allows for a telephone number (with one or more letter extensions if necessary) to serve both as a telephone identifier as well as an identifier for information in electronic form (i.e., as a gateway to one or more web pages where more information related to the print media may be retrieved). With the letter extensions, one may associate multiple sites of information with a single phone number, and yet, a person reading the print media will still recognize the number as a telephone number and be able to either call the telephone number directly or go to a web page, such as ezcodes.com, type in the number (plus extensions, if present) and view additional or related information online.

Further, the technology disclosed herein provides for the significant advantage of allowing persons to easily navigate to specific web pages. It is often difficult to locate the web page of a store or other commercial entity. For instance, if one types “Target” into a search engine hoping to go to the site for the store with that name, one may be faced with hundreds or thousands of hits, none of which relate to the store being sought. However, if one has a phone book, one could look Up the telephone number of a Target store, go to a web page such as ezcodes.com, enter the phone number, and be able to clink on a link to that specific Target store (or to the national Target store web page), so long as the Target store subscribed to the services offered by this disclosure. Thus, by associating telephone books and telephone numbers (with which almost everyone is already comfortable in using) with the Internet, the present disclosure effectively makes navigating electronic information much easier and straightforward. In particular, locating difficult to find web sites is rendered uncomplicated.

### EXAMPLE 3

Assume that a person reads the following classified ad in a newspaper:

For Sale 1995 Red Honda Accord LS

2DR Low MI. Exec Cond. A/C, Sunroof, CD

713-555-9055aa www.ezcodes.com

The reader can either call the owner directly or visit the EZcodes.com web site for more information.

If the person chooses to go to the EZcodes.com web site, an HTML screen may be displayed that will request the user to input the phone number of the ad that they wish to view. The phone number and letter extension serves as a unique identifier that may be used to automatically display the proper ad (in this case, the Honda ad with associated telephone number of 713-555-9055aa.) If the ad's phone number is typed without the letter extension, a listing page (which may be termed a “jump page”) may be displayed with all the ads associated with that telephone number. If multiple ads are not associated with a telephone number, and the telephone number without the letter extension is typed, a jump page may not be displayed, and the ad may be automatically displayed.

If the an individual wishes to advertise multiple items under one phone number, an extension may be added to the end of the phone number. For example:

For Sale 1995 Red Honda Accord LS

2DR Low MI. Exec Cond. A/C, Sunroof, CD

713-555-9055aa www.ezcodes.com

and

For Sale 1995 Red Honda Accord LS

2DR Low MI. Exec Cond. A/C, Sunroof, CD

713-555-9055ab www.ezcodes.com

A user may either type just the phone number or the phone number with the extension. If the user types 713-555-9055 without an extension, a jump page with the following information may appear:

Please click on the appropriate Ad that you wish to view under phone #713-555-9055:

A—1995 Red Accord

B—3/2 Clearlake Home

If a user types 713-555-9055aa, a detailed listing for the red Honda Accord may be displayed on the screen and may possibly include a picture of the car and other information that was not included in the print media due to space restrictions of that particular publication.

### EXAMPLE 4

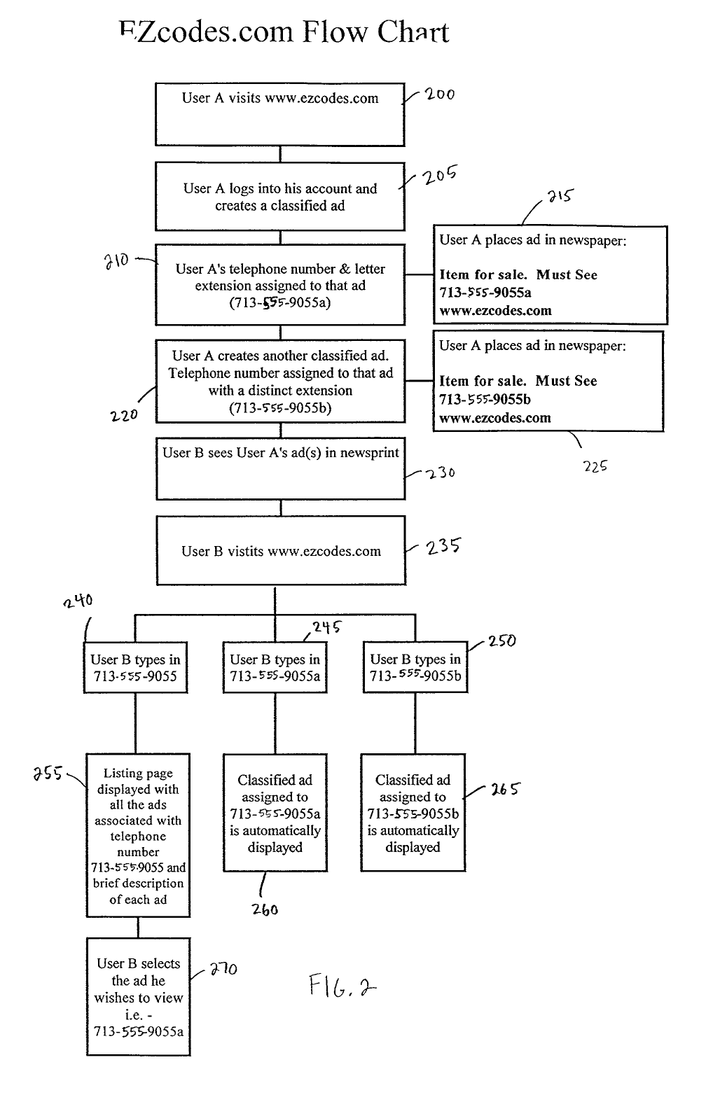

One embodiment of the present disclosure is illustrated in the flow chart of FIG. 2. There, a user visits a web-site, such as www.ezcodes.com in step 200. That user logs on in any one of a number of ways known in the art (for instance, by entering a user identification and associated password that may be set-up in advance). Once logged onto the site, the user may then create a classified advertisement in step 205. The creation of the classified ad may be done via a number of different methods, all known in the art. For example, the user may be provided a window into which text may be entered regarding the classified ad. The user may be prompted to enter one or more graphics files (or multimedia files such as sound or movies) to be associated with the ad so that users may obtain more information about the item(s) being advertised. In step 210, the user's telephone number is correlated with the advertisement and its associated network address. One or more extensions may be appended to the telephone number. In FIG. 2, the extension ‘a’ is appended to the phone number to provide a mechanism whereby more than one network address and/or display pages may be associated with the single telephone number identifier.

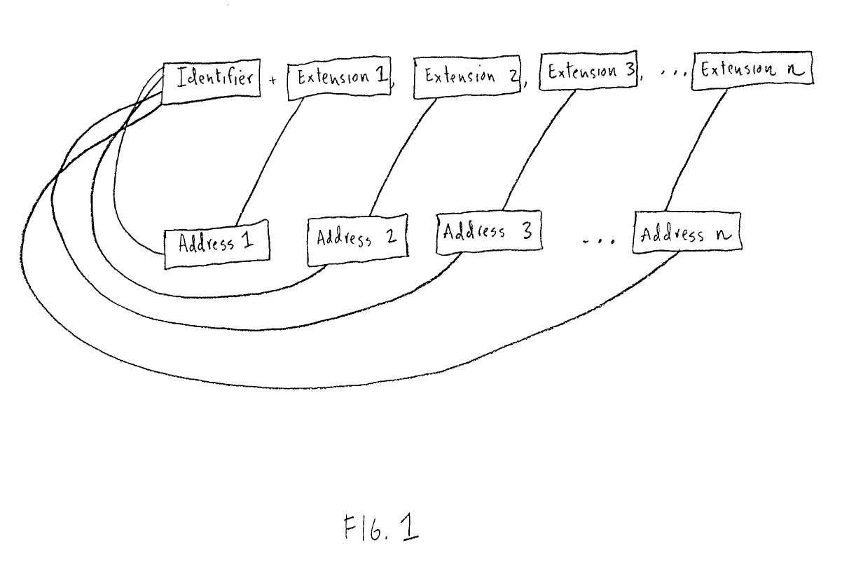

In step 215, the user places an advertisement in print media corresponding to the computerized advertisement created in step 200. As illustrated, the print media advertisement points the reader to the appropriate web-page and identifier (with our without an extension) where further information concerning the items for sale may be viewed. In steps 220 and 225, it is illustrated how another item may be advertised by the same user having the same phone number. As shown, the second item being advertised may be associated with a second extension appended to the telephone number. In this case, the second extension is the letter ‘b.’ FIG. 1 generally illustrates the correlation between identifiers and network addresses. There, it is shown that a single identifier (such as a phone number) may be correlated with one or more network addresses. Additionally, one or more extensions of that identifier may be correlated with specific network addresses. As disclosed herein and specifically in this Example, each one of those addresses may correspond to a classified ad or other information.

In step 230 of FIG. 2, a user, User B, sees the print media advertisement created in step 225. After noting the instruction in the print ad, User B visits www.ezcodes.com in step 235. Within that web site, User B may choose one of three permutations corresponding to the identifier. In step 240, User B simply types in the telephone number identifier listed in the print media advertisement. In that case, a page may be displayed that shows all the advertisements associated with the telephone number (step 255). In one embodiment, this page (which may be referred to as a ‘jump page’) may display links to all ads associated with that telephone number but having different extensions. Thus, the jump page may display the ads associated with extensions ‘a’ and ‘b’ illustrated in FIG. 2. In step 270, it is illustrated that User B may then click on a link to the ad associated with the extension ‘a’ to view more information about that ad.

In steps 245 and 250, it is shown that User B may type in the phone number plus the extension into the web site. In this case, the associated computerized advertisement may be shown directly without the viewing of an intermediate jump page.

### EXAMPLE 5

In one embodiment, the technology described herein may be used in conjunction with existing technology relating to targeted banner advertisements. In particular, a user may visit a web site such as ezcodes.com or a similar site using techniques disclosed herein and enter a telephone number identifier (with or without extensions such as “a,” “aa,” “ab,” or the like) in order to retrieve online information associated with that number. In response to the request for information, one or more banner advertisements (or other advertising media) may be displayed. In particular, one or more banner advertisements may be displayed that correspond to the telephone number identifier. More particularly, the banner advertisements may be for establishments that have correlated their advertisements with the particular area code of the telephone number identifier. For instance, if a user typed in the following telephone number identifier into ezcodes.com, “281-555-3018,” a banner advertisement may be displayed for a restaurant located in Houston, Tex. (which has 281 as one of its area codes). In this way, the present disclosure provides for the additional benefit of providing for the ability to present targeted advertisements to remote users based on the area code corresponding to information that they are requesting.

All of the methods, systems, and apparatus disclosed and claimed herein can be made and executed without undue experimentation in light of the present disclosure. While the techniques of this invention have been described in terms of specific embodiments (and specific examples), it will be apparent to those of skill in the art that many variations may be applied to the disclosed methodologies and in steps of methods described herein without in any way departing from the concept, spirit and scope of the invention. For instance, methodology described herein may be applied not only to telephone numbers, but to any identifier. Further, one may utilize any additional technology known in the art with the present disclosure; for instance, it will be understood that banner advertisements and the like may be used in conjunction with the display and or request for information, as is known in the art. Likewise, methodology disclosed herein may be utilized as part of a system, including a memory device and a microprocessor in communication with such a memory (the memory communicating with the microprocessor as is known in the art) to carry forth instructions necessary to implement the techniques described herein.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A system for correlating an identifier in print media to information in electronic format, comprising:
a graphical user interface coupled to a network including the information located at a network address, the user interface being configured to receive a request from a remote user, the request including the identifier from the print media; and
a server coupled to the network and configured to:
receive the request;
correlate the identifier with the address;
display the address corresponding to the identifier; and
provide a link to the information using the address.

2. The system of claim 1, wherein the network comprises the Internet.

3. The system of claim 1, wherein the network comprises a local area network.

4. The system of claim 1, wherein the graphical user interface comprises a web page.

5. The system of claim 1, wherein the identifier comprises a telephone number.

6. The system of claim 5, wherein the telephone number comprises an extension.

7. The system of claim 5, wherein the server is further configured to display an advertisement corresponding to the telephone number.

8. A method for correlating an identifier in print media to information in electronic format, comprising:
assigning an identifier to an electronic address of the information;
receiving with a server a query comprising the identifier over a network from a remote user;
displaying the address corresponding to the identifier; and
providing a link to the information using the address.

9. The method of claim 8, wherein the network comprises the Internet.

10. The method of claim 8, wherein the network comprises a local area network.

11. The method of claim 8, wherein the identifier comprises a telephone number.

12. The method of claim 11, wherein the telephone number comprises an extension.

13. The method of claim 11, further comprising displaying an advertisement corresponding to the telephone number.

14. A method for associating information from print media with online information via a telephone number identifier, comprising:
associating the telephone number identifier with a URL address;
providing an online query field configured to receive the telephone number identifier from a remote user;
displaying the URL address to the remote user in response to the query; and
providing a link to the URL address.

15. The method of claim 14, wherein the information from print media and the online information comprise classified advertisement information.

16. The method of claim 14, wherein the information from print media and the online information comprises news information.

17. The method of claim 14, wherein the information from print media and the online information comprises commercial information.

18. The method of claim 14, wherein the telephone number identifier comprises an extension.

19. The method of claim 18, wherein the online query field is configured to receive the telephone number identifier with or without the extension.

20. The method of claim 19, wherein the method further comprises displaying two or more URL addresses associated with two or more extensions in response to the receipt of the telephone number identifier without the extension.

21. The method of claim 14, further comprising display an advertisement corresponding to the telephone number identifier.

22. A computer readable media containing program instructions for associating information from print media with online information via a telephone number identifier, the media comprising instructions for:
associating the telephone number identifier with a URL address;
providing an online query field configured to receive the telephone number identifier from a remote user;
displaying the URL address to the remote user in response to the query; and
providing a link to the URL address.

23. The media of claim 22, wherein the instructions comprise HTML code.

24. The media of claim 22, wherein the information from print media and the online information comprise classified advertisement information.

25. The media of claim 22, wherein the information from print media and the online information comprises news information.

26. The media of claim 22, wherein the information from print media and the online information comprises commercial information.

27. The media of claim 22, wherein the media further comprises instructions for displaying an advertisement corresponding to the telephone number identifier.
